(19) United States
(12) Patent Application Publication
(10) Pub. No.: US 2005/0132201 A1
(43) Pub. Date: Jun. 16, 2005

(54) Server-based digital signature

(76) Inventors: Andrew J. Pitman, Dunwoody, GA (US); David McDonald, Herndon, VA (US); Sean Finnegan, Leesburg, VA (US); Steven Buxton, Ashburn, VA (US); Robert Matles, Chicago, IL (US)

Correspondence Address: ACCENTURE CHICAGO 28164;BRINKS HOFER GILSON & LIONE, P O BOX 10395, CHICAGO, IL, 60610, US

(21) Appl. No.: 10/948,365

(22) Filed: Sep. 23, 2004

Related U.S. Application Data
(60) Provisional application No. 60/505,825, filed on Sep. 24, 2003.

(51) Int. Cl. H04L 9/00

(52) U.S. Cl. 713/176

(57) ABSTRACT

Electronic signature functions, such as electronically signing an electronic record, verification of an electronic signature and issuance of keys, may be performed by a server or other central computer. For electronic signing, the server may access a key on a protected database and encryption programs to electronically sign an electronic record. For signature verification, the server may receive the electronic record and electronic signature, determine a key to decrypt the electronic signature, and then determine whether the electronic signature is valid. For issuance of keys, the server may receive a user request to generate keys, may generate the keys, and store the keys in a database which is accessible by the server, but which may not be accessible by the user.

### RELATED APPLICATIONS

This application claims the benefit of U.S. Provisional Application No. 60/505,825, filed Sep. 24, 2003, which is hereby incorporated by reference herein in its entirety.

### BACKGROUND

A signature has historically represented any mark made with the intention of validating a transaction. Associating a signature with a transaction may serve two purposes. First, the signature may “authenticate” the signer. Specifically, the signature indicates who signed a document, message or record and should be difficult for another person to produce without authorization. Second, the signature may “authenticate” the document. Specifically, the signature identifies what is signed, making it impracticable to falsify or alter either the signed matter or the signature without detection.

Transactions were traditionally reduced to writing. However, the traditional methods are undergoing fundamental change. In many instances, the information exchanged to effect the transaction never takes paper form. Instead, the transaction may be represented partially or entirely in electronic format, with the signature taking the form of an electronic signature. The electronic signature, similar to the traditional signature, can meet the dual purposes of signer authentication and document authentication. In short, the electronic signature may verify that the document originated from the individual whose signature is attached to it and that it has not been altered since it was signed.

One such form of an electronic signature is a digital signature. A digital signature may be based on cryptography using keys. Keys map data from a legible format (either human or machine format) to an illegible format, and vice-versa. Two examples of different types of encryption models using keys include: (1) a symmetric model; and (2) an asymmetric model. The symmetric model teaches that the message sender and the recipient share the same key. Specifically, the same key used to encrypt a message is used to decrypt the message. The symmetric model suffers from certain drawbacks. First, the symmetric model requires secure distribution of the key to both the message sender and the recipient. Second, because many people share the same key, this key cannot be used to verify that a particular person created the message, and is therefore of limited value in authenticating the signer.

The second type of encryption is the asymmetric model, which is also known as public key infrastructure (PKI). The asymmetric model uses two different but mathematically related keys. One key is used for creating a digital signature or transforming the data into a seemingly unintelligible form, and another key is for verifying a digital signature or returning the message to its original form. The two keys in the asymmetric model are arbitrarily termed the private key, which is known only to the signer, and the public key, which is ordinarily more widely known and freely distributed. Each key in the key pair performs the inverse function of the other so that what one key does, only the other can undo. Thus, messages encrypted with the private key may be decrypted with the public key, and vice versa. Further, although the keys of the pair are mathematically related, it is typically computationally infeasible to derive the private key from knowledge of the public key. Many people may know the public key of a given signer and use it to verify that signer's signatures. Unlike the symmetric model, they cannot discover the signer's private key and use it to forge signatures. The asymmetric model, however, still requires secure distribution of the private key to the computer of the message sender if the algorithm for generating the public-private key pair is on a different computer than the message sender. Further, the asymmetrical model, because of the use of public and private keys, results in slow encryption and decryption, and creates large message sizes.

Typically, to sign a document or any other item of information, the signer first delimits precisely the borders of what is signed. After which, a hash function is used to compute a hash result for the delimited portion. The hash function is a program which creates a digital representation in the form of the hash result of a standard length, which is usually much smaller than the delimited portion but which is substantially unique to it. Any change to the delimited portion (due to alteration) produces a different hash result when the same hash function is used. The signer's software then transforms the hash result into a digital signature using the signer's key. For example, in the asymmetric model, the private key is used to transform the hash result. The resulting digital signature is thus unique to both the message and to the key used to create it.

Verification of a digital signature may be accomplished by computing a new hash result of the original message by means of the same hash function used to create the digital signature. Then, using the key (such as the public key in the asymmetric model) and the new hash result, the verifier may check: (1) whether the digital signature was created using the corresponding private key; and (2) whether the newly computed hash result matches the original hash result which was transformed into the digital signature during the signing process. In the asymmetric model, the verification software confirms that the digital signature is verified if: (1) the signer's private key was used to digitally sign the delimited portion, which is known to be the case if the signer's public key was used to verify the signature because the signer's public key will verify only a digital signature created with the signer's private key (signature authentication); and (2) the message was unaltered, which is known to be the case if the hash result computed by the verifier is identical to the hash result extracted from the digital signature during the verification process (document authentication).

An individual may install digital signature software on his or her computer. With the asymmetric model, the individual may assume any identity he or she chooses and generate a key pair. The individual may then release the public key for general distribution with no guarantee that the identity chosen by the individual is authentic. To ensure that the identity of the individual is authentic, a third party may be used to vouch for the individual's identity and the individual's public key. This entity is referred to as a certification authority. The certification authority may be a trusted third party that issues digital certificates to its subscribers, binding their identities to the key pairs they use to digitally sign electronic communications. Typically, a digital certificate may include: the name, organization, and address of the subscriber; the subscriber's public key; the expiration date of the public key; the name of the issuing certification authority; the digital signature of the issuing certification authority; the issuing certification authority's public key, and other pertinent information about the subscriber. These certificates may be stored on an end user's computer. Or, rather than storing on a user's computer, the certificates may be stored on protected servers. Keys for digital signatures are then sent to a user's browser only after authentication is proven by shared secrets. The keys are not permanently stored on the user's computer and vanish after the session is ended.

The solutions described above have their drawbacks. Using either the symmetric or asymmetric models require that keys be sent to the party signing the document and the party verifying the signed document. However, the keys are usually sent through a network, such as the Internet, which creates a threat of having the key captured while in network transit. While security concerns are less for the public key in the asymmetric model, the private key must still be distributed, which creates a threat of key capture. In addition, a widespread electronic signature system may include millions of users. Distributing keys to all of the users is impractical. Further, requiring the signer to manage safely the storage of his or her keys is unrealistic. Human nature shows that keys (whether car, house, or digital signature keys) will ultimately be misplaced.

Likewise, the solutions storing certificates on protected servers have drawbacks. Similar to traditional PKI solutions, the keys are distributed to the user's browser, creating the threat of key capture. Moreover, the cost of devising this alternative PKI solution is significant and may cost millions of dollars to enable users to access a digital signature system.

Thus, there is a need to have a more secure and cost-efficient method and apparatus for computerized signatures.

### BRIEF SUMMARY

In one embodiment of the invention, functions of the electronic signature engine (such as the electronic signing of electronic record, verifying of an electronic signature, user registration, etc.) may be performed at a central device. One example of a central device may comprise a server or a central computer in a network. The central device may be a device separate from the device requesting electronic signature of the document, the device requesting electronic signature verification, and/or the device requesting generation of a signature key.

In one aspect of the invention, the central device may electronically sign electronic records. The electronic records may be generated at the central device, or may be generated at another device, such as a user device or an application, and sent to the central device. A user at the user device may access the central device via a network, such as the Internet. User identification may be provided, either automatically or manually by the user, to the central device. The user identification may comprise user login information (such as a user name or user ID) and/or user private identification (such as a password, PIN, shared secrets, biometric information, etc.). The user may also authorize the central device to electronically sign the electronic record. The central device may electronically sign the electronic record by accessing an electronic signature engine, user signing data (such as keys and a certificate). The electronic signature engine, keys and certificate may be stored with the central device, or may be accessible by the central device. For example, the keys may be stored on a database accessible by the server. Further, the keys may be encrypted, such as encrypted based on the user private identification. In this configuration, the electronic signature engine, keys, and certificate need not be stored or be temporarily resident at the end user device. Therefore, the user signing data, such as the keys, need not be transmitted through the network.

In another aspect of the invention, the central device, such as a server, may verify electronic signatures. The electronic record and an electronic signature may be sent from a communication device, such as the user device or application device, to the central device. The central device may receive an authorization to verify the electronic signature. The central device may determine a key for the electronic signature and may verify, using the key, that the electronic record has not been altered since the electronic signature was generated.

In still another aspect of the invention, the central device may generate user signing data for electronic signatures. A user on a user device may request the central device to generate the user signing data, such as a key or keys. The central device may generate the user signing data and store the user signing data in a database which is accessible by the central device, but which may not be accessible by the user at the user device. The central device may further encrypt the user signing data stored in the database. The encryption of the user signing data may be based on private identification of the user, such as a password, PIN, biometric information, etc.

### BRIEF DESCRIPTION OF THE DRAWINGS

FIG. 1 is a block diagram of one configuration of the invention with a server, applications, user devices, and network.

FIG. 2 is a block diagram of another configuration of the invention with a server, user devices, and network.

FIG. 3 is a block diagram of yet another configuration of the invention with an application, user devices, and network.

FIG. 4 is an expanded block diagram of server shown in FIG. 1.

FIG. 5 is a block diagram of an exemplary electronic signature engine 20 depicted in FIG. 1.

FIG. 6 is a flow chart of one embodiment of electronically signing an electronic record.

FIG. 7 is a flow chart for checking the certificate and electronically signing the electronic record.

FIG. 8 is a flow diagram of an exemplary electronic signing of an electronic record with the application in the flow diagram support web services.

FIG. 9 is a flow diagram of another exemplary electronic signing of an electronic record with the application not being able to support web services.

FIG. 10 is a flow chart of an exemplary signature verification process.

FIG. 11 is a flow chart of an exemplary user registration process.

FIG. 12 is a flow chart of an exemplary application configuration process.

### DETAILED DESCRIPTION OF THE DRAWINGS AND THE PRESENTLY PREFERRED EMBODIMENTS

By way of overview, the preferred embodiments described below relate to a method and system for electronic signatures. In one embodiment, functions of the electronic signature engine (such as the electronic signing of electronic record, verifying of an electronic signature, user registration to generate a key, etc.) may be performed not at the requesting device (e.g., the device requesting to have the record electronically signed; the device requesting to verify an electronic signature; or the device requesting to have an electronic key generated). Rather, the functions of the electronic signature engine may occur at a third party device, such as a central device. The central device may comprise a device which is separate from the requesting device.

One example of a central device may comprise a server or a central computer in a network, which may access the electronic signature engine. The server or central computer may include an operating system, such as Windows® Server Operating System. The operating system may be used to generate the functions of the electronic signature engine 20. For example, Application Program Interfaces (APIs), such as cryptography APIs, may be used to generate the functions of the electronic signature engine.

This configuration is unlike prior electronic signature solutions which required functions of the electronic signature engine be performed at the requesting device. For example, prior approaches required code for the electronic signature functions to be resident at the user device. Prior solutions further required that a certificate (such as an X.509 certificate) be resident at least temporarily on the user device. For example, the certificate may be sent from a server through a potentially insecure network to the user device for temporary storage when the user wishes to electronically sign. The user device then performs the digital signature, accessing the digital signing software, the client's key (such as the private key), and the certificate stored in the user device.

By contrast, in one embodiment, the electronic signature engine, the keys, and/or the certificate may be stored securely on or may be accessible by a central device (such as a server) during the electronic signature process. A user may access a central computer (such as a server) via a network, provide user identification, and electronically sign the electronic record at the central computer. The user identification may comprise user login information (such as a user name or user ID) and/or user private identification (such as a password, PIN, shared secrets, biometric information, etc.). This arrangement promotes non-repudiation of electronic signatures.

In another embodiment, the electronic signature engine may be stored securely on or may be accessible by a central device (such as a server) during the verification process. A party wishing to verify an electronic signature may access the central device and send the electronic record and the electronic signature. The central device may then verify that the electronic record has not been altered since the electronic signature was generated.

In still another embodiment, the electronic signature engine may be stored securely on or may be accessible by a central device (such as a server) during user registration process. The user may receive signing data (such as a key or keys) which may be used when electronically signing a record. The user may identify himself, herself, or itself to the central device. The central device may generate the key or keys, and store the keys in an accessible database. The keys need not be sent to the user.

Because it is centrally-based, the electronic signature engine may avoid many of the pitfalls of client-side signing approaches. The keys and the certificate need not be sent to the user device, thereby avoiding transmission through a potentially insecure network. Moreover, some prior approaches stored the certificate on the user device. This approach fails when a user wishes to sign from more than one computer. For instance, a user may wish to electronically sign from his or her home computer some of the time and from the office computer other times. With a centrally-based solution, the user may sign from any computer which may access the central computer or server. In addition, the client-based approach in the prior art creates an enormous management challenge because users are required to maintain their certificate on their individual machine. Another challenging complexity is that there are a wide variety of operating systems and web browsers that are available to clients. Applications that require signing from a diverse population—like E-Government applications—cannot dictate the operating system, virtual machine, or web browser of the user. Further, traditional digital signature solutions in the prior art require a full Public Key Infrastructure (PKI), which includes Certificate Authorities (CA), Certificate Revocation Lists (CRL), and User Certificates to be deployed and managed. These infrastructures can be very costly. In one embodiment of the invention, a fully functional PKI based digital signature engine may be implemented on a server (such as on the .Net Framework) without the costly Public Key Infrastructure.

The term “electronic signature” may comprise data, an electronic sound, a symbol, or a process, attached to or logically associated with a record (such as an “electronic record”) and executed or adopted by a person with the intent to sign the record. One example of an electronic signature comprises a digital signature based on cryptography using keys. As discussed above, a digital signature comprises extra data, generated using key encryption, appended to the record which identifies/authenticates the person signing and the record. The term “electronic record” may comprise a contract, data, form, document or other record created, generated, sent, communicated, received, or stored electronically. For example, a web page or web form, XML data or XML form, Word® file, PDF file, or text file may comprise an electronic record.

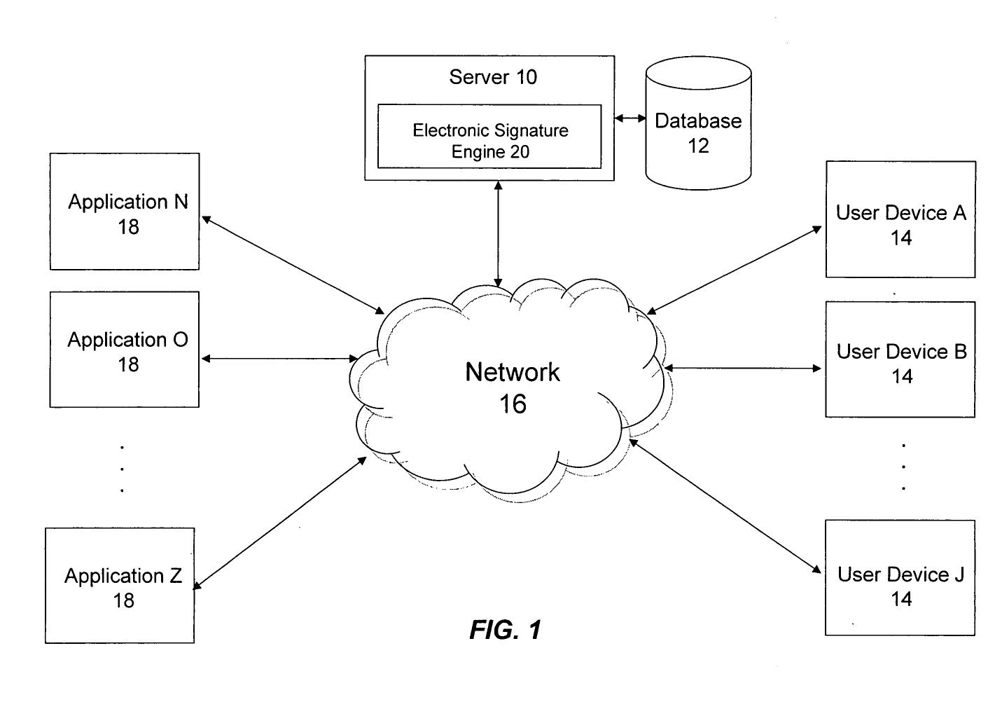

As discussed above, in one embodiment of the invention, the functions of the electronic signature engine, such as electronically signing documents, may be performed at a central device which is different from the user's device (e.g., the user requesting to sign the document). FIGS. 1-3 show three exemplary configurations; however, other configurations are possible.

Turning to the drawings, wherein like reference numerals refer to like elements, FIG. 1 shows a block diagram of one configuration. FIG. 1 shows a plurality of user devices 14, designated as User A, User B, and User J. Any number of user devices may be implemented. The plurality of user devices may comprise any type of electronic device capable of communication including, for example, a computer, a personal digital assistant (PDA) and/or a telephone (such as a cellular telephone). FIG. 1 further shows a plurality of applications 18, designated as Application N, Application O, and Application Z. Any number of applications may be implemented. Individuals or organizations may provide applications 18. For example, government organizations, such as the department of motor vehicles, the department of revenue, or the like, may provide applications. In the example of the department of motor vehicles, the application may comprise a license renewal application. As another example, companies may provide services to customers via the applications. The applications may include: (1) online forms to include those requiring signature, e.g., Tax Forms; Business Registration; Etc.; (2) Voter Registration; (3) Unemployment Benefits; (4) Electronic funds transfer; (5) Commitments to Actions or Contracts; (6) Notifications Requiring Receipts; (7) Payment Submission Confirmation; and (8) Government to Government Transactions (i.e., Local Police to Federal Police). Similar to the user devices, the plurality of applications may comprise any type of electronic device capable of communication, such as a computer. The application may comprise a software program that allows users to generate an electronic record, such as filling out online forms, submitting data, or generating documents. These forms, data, and/or documents may be the digital representation of traditional paper forms, data, and/or documents. A user operating one of the user devices 14 may wish to electronically sign the electronic record. The user may communicate this wish with the application via network 16. Network 16 may comprise any means by which electronic devices may communicate with one another. For example, network 16 may comprise a Local Area Network (LAN), a Metropolitan Area Network (MAN), and/or a Wide Area Network (WAN). One example of network 16 is the Internet.

Server 10 may comprise any type of electronic device capable of communication including, for example, a computer. User devices 14 and applications 18 may communicate with server 10 via network 16. Server 10 may include electronic signature engine 20. Electronic signature engine 20 may be resident in server 10, as depicted in FIG. 1, or may be accessible by server 10. Moreover, server 10 may access database 12 to perform functions of the electronic signature engine 20. In one embodiment, server 10 may include a Windows® Server Operating System. The Windows® Server Operating System may be used to generate the functions of the electronic signature engine 20. For example, Application Program Interfaces (APIs), such as cryptography APIs, may be used to generate the functions of the electronic signature engine 20. Microsoft® Visual Studio® may be used to generate, edit, test, and debug computer code using the APIs.

The electronic signature engine 20 may comprise functional processes including: signing; signature verification; user registration; and application configuration. One, some, or all of the above functional processes may be included in the electronic signature engine 20. Moreover, the electronic signature engine may be completely self-contained, providing all of the functional processes for electronic signatures, such as signing and user registration. Further, other functional processes relating to electronic signatures may be included.

The signing process may be initiated by an application 18 or by a user device 14, such as after a data entry operation with the user of user device 14. As discussed in more detail below, the application may call server 10 and then redirect the user at user device 14 to the server's web interface. Alternatively, the user device may initiate the signing process.

The electronic signature engine 20 may display the electronic record in human readable form, such as by using an XSL Stylesheet, and prompt the user to enter his or her user private identification (such as a password, PIN, biometric information, etc.). The electronic signature engine may decrypt the user's key using the private identification. The electronic signature engine 20 may then electronically sign the electronic record (e.g., canonicalizes the electronic record, hashes it, signs the hash, and saves the signed hash in the electronic record). The application 18 may receive notification from the server 10 (such as via redirect) and then retrieve the signed electronic record. The application 18 may store the signed version of the electronic record as appropriate for that application.

The signature verification process may verify the signature of an electronic record. The signature verification process may be called by application 18, by user device 14, or by another communication device. For example, when the application 18 requests verification, the application 18 may pass the electronic record and the signature. The signature verification process of the electronic signature engine may verify that the signature matches the electronic record being passed. As discussed in more detail below, if the electronic record has been changed in any way, the verification would fail, indicating that the content was not the original signed electronic record.

The user registration process allows a user to register with the electronic signature engine. The first time that a user is asked by an application 18 to sign a document, the user may register with the electronic signature engine. The user registration process of the electronic signature engine 20 may provide a simple user profile. The user may be assigned or may generate a private identification (such as a PIN number, a password, biometric information, etc.). The electronic signature engine 20 may also assign the user a certificate (such as a X.509 certificate) and an associated private key, both of which may be stored in database 12. The private key may be encrypted using the user's private identification. For example, the key may be encrypted with the PIN using a symmetric key algorithm (triple DES) before it is saved in database 12. In this manner, a user may register once to use the electronic signature engine, and can use his or her certificate for many applications that share the common electronic signature service. Further, the user may register, receive his or her certificate, and then sign the electronic record all in one session with the service. This allows the application to use the service without having to guarantee that each of their users has an existing certificate/service identification beforehand.

The application configuration process may allow for configuration of an application 18. As shown in FIG. 1, the electronic signature engine 20 may support multiple applications 18. Configuration of the application may include an assigned Application ID so that the signature engine may identify the application during future processes, such as signing and signature verifying.

Server 10 and the electronic signature engine 20 may be integrated easily with existing applications 18. The integration of the server with the applications may include: (1) a simple application configuration process to configure a new application; (2) no changes (or minimal changes) to the application security for integration with the electronic signature engine (e.g., each application may maintain their existing logon and user profile data); (3) no database changes to the application; (4) easily invoking of the electronic signature engine 20 by the application 18, such as by using standard SOAP (Simple Object Access Protocol) or HTTP Posts; (5) data or documents being maintained at the application and not with server 10 or database 12 (after the data is electronically signed, the electronic signature engine may return the signed data to the calling service or application); (6) an application can provide signing capabilities through the electronic signature engine for many different types of data and documents; and (7) configuration of the electronic signature engine 20 for any application, such as XSL style sheets, so that the user may see a human readable representation of the data that he or she is signing.

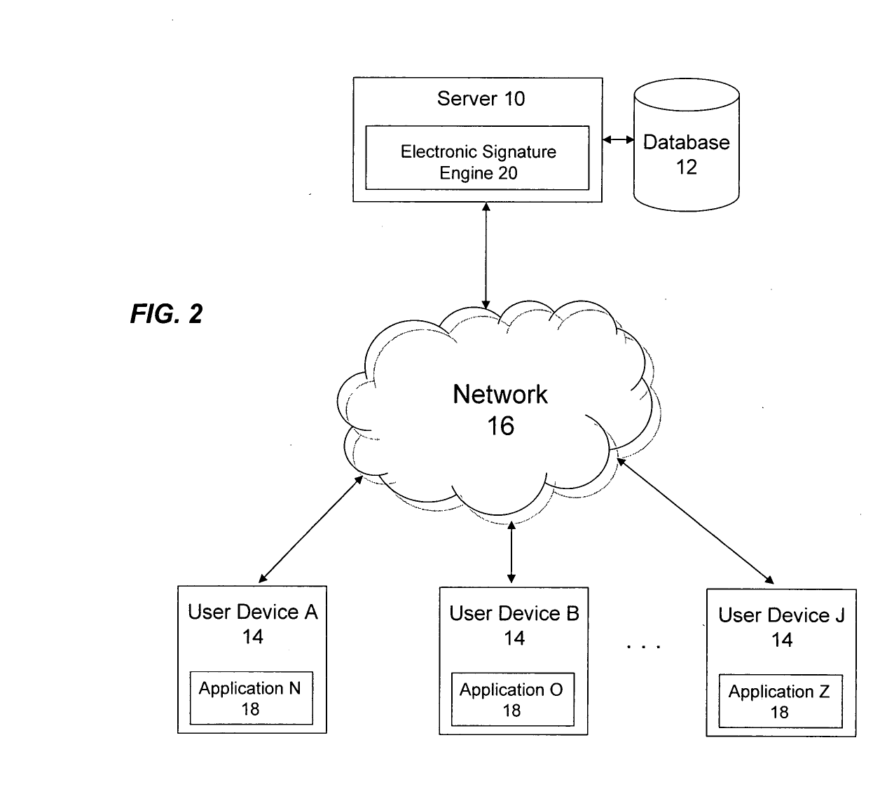

With reference to FIG. 2, there is shown a block diagram of another configuration. Instead of user devices 14 communicating with applications 18, the applications 18 are resident in user devices 14, as shown in FIG. 2. For example, the application 18 may be a software program executed in a user device 14 in which the user fills out forms, submits data, or generates documents. If the user wishes to electronically sign a document, the user device 14 may communicate via network 16 with server 10. The server 10 may access the database 12 and the electronic signature engine 20 to electronically sign the forms, data, or documents submitted by the user device.

The electronic signature engine 20 depicted in FIG. 2 may include the signature, signature verification, and user registration processes described above. Moreover, the application 18 resident on user device 14 may be configured with server 10 using the application configuration process described above. Further, other functional processes relating to electronic signatures may be included.

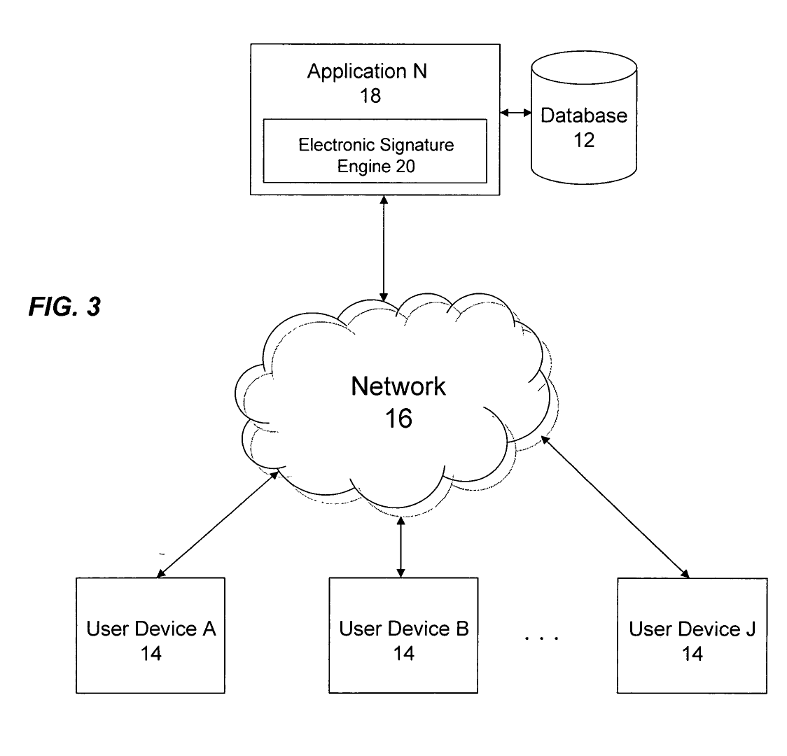

With reference to FIG. 3, there is shown a block diagram of yet another configuration. Instead of user devices 14 communicating with the electronic signature engine 20 via server 10, user devices may communicate with the electronic signature engine 20 via an application, as shown in FIG. 3. Similar to the applications described with respect to FIG. 1, the application may comprise a software program that allows users to generate an electronic record, such as filling out online forms, submitting data, or generating documents. When the user of one of the user devices 14 wishes to use one of the functions of the electronic signature engine 20, such as electronically signing a document, the document may be electronically signed with the application 18. The application 18 may use the electronic signature engine 20, which may be resident in the application as shown in FIG. 3 or accessible by the application 18, to sign the document. The electronic signature engine 20 depicted in FIG. 3 may include the signature, signature verification, and user registration processes described above. Further, other functional processes relating to electronic signatures may be included. Similar to the electronic signature engine 20 depicted in FIG. 1, the electronic signature engine 20 in FIG. 3 may use Application Program Interfaces (APIs), such as cryptography APIs, to generate the functions of the electronic signature engine 20.

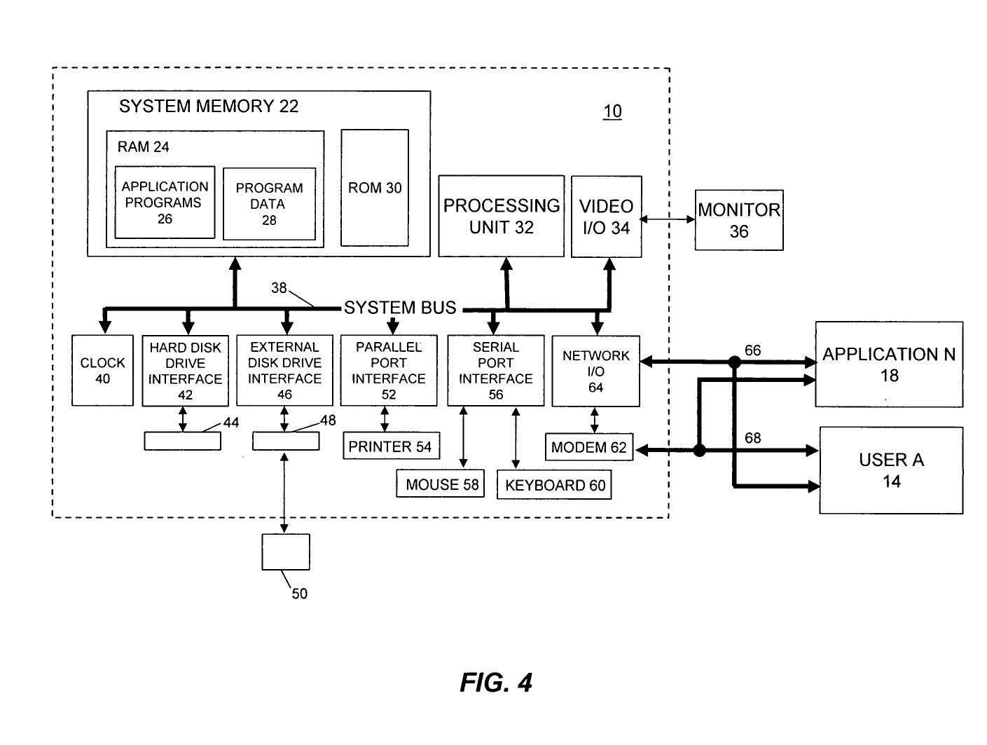

With reference to FIG. 4, an expanded block diagram of the configuration in FIG. 1 is shown. Server 10 may comprise a general purpose computing device, including a processing unit 32, a system memory 22, and a system bus 38, that couples various system components including the system memory 22 to the processing unit 32. The processing unit 32 may perform arithmetic, logic and/or control operations by accessing system memory 22. The system memory 22 may store information and/or instructions for use in combination with processing unit 32. The system memory 22 may include volatile and non-volatile memory, such as random access memory (RAM) 24 and read only memory (ROM) 30. A basic input/output system (BIOS) containing the basic routines that helps to transfer information between elements within the computer environment 20, such as during start-up, may be stored in ROM 30. The system bus 38 may be any of several types of bus structures including a memory bus or memory controller, a peripheral bus, and a local bus using any of a variety of bus architectures.

The computing environment 20 may further include a hard disk drive 44 for reading from and writing to a hard disk (not shown), and an external disk drive 48 for reading from or writing to a removable external disk 50. The removable disk may be a magnetic disk for a magnetic disk driver or an optical disk such as a CD ROM for an optical disk drive. The hard disk drive 44 and external disk drive 48 may be connected to the system bus 38 by a hard disk drive interface 42 and an external disk drive interface 46, respectively. The drives and their associated computer-readable media provide nonvolatile storage of computer readable instructions, data structures, program modules and other data for the server 10. Although the exemplary environment described herein employs a hard disk and an external disk 50, it should be appreciated by those skilled in the art that other types of computer readable media which can store data that is accessible by a computer, such as magnetic cassettes, flash memory cards, random access memories, read only memories, and the like, may also be used in the exemplary operating environment.

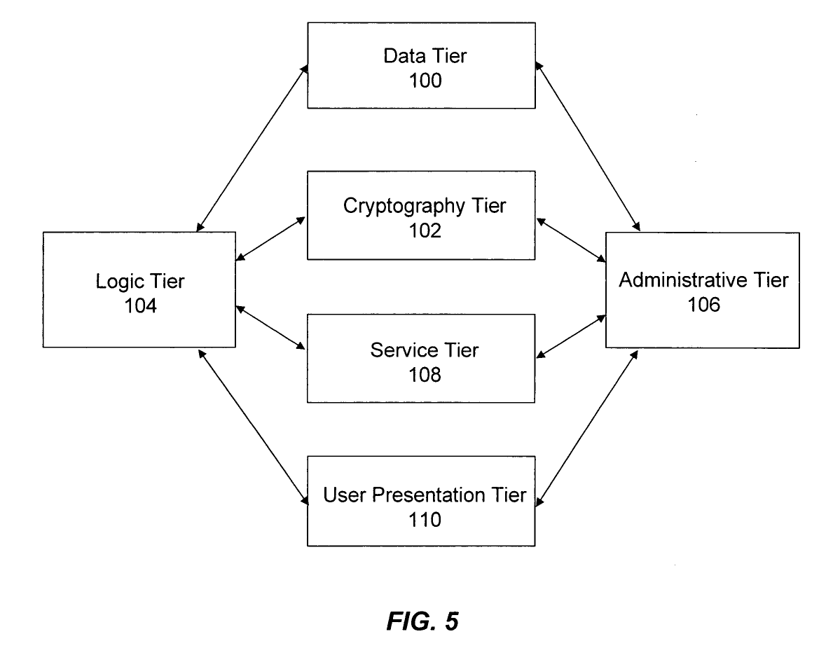

A number of program modules may be stored on the hard disk, external disk 50, ROM 30 or RAM 24, including one or more application programs 26, other program modules (not shown), an operating system (not shown), and program data 28. One such application program may comprise the electronic signature engine 20 and include the functionality as detailed in FIGS. 5-12. In addition, one example operating system is the Windows® Server Operating System. Further, the database 12, depicted in FIG. 1 as separate from server 10, may be included within server 10. For example, database 12 may be located in system memory 22, such as in RAM 22 or ROM 30, or in the hard disk.

Server 10 may further include clock 40. Clock 40 may comprise an oscillator-generated signal that provides a timing reference. The clock 40 may be a discrete device within server 10, as depicted in FIG. 4, or may be included within processing unit 32. As described below, clock 40 may be accessed during executing functions of the electronic signature engine 20.

A user may enter commands and/or information, as discussed below, into server 10 through input devices such as mouse 58 and keyboard 60. Other input devices (not shown) may include a microphone (or other sensors), joystick, game pad, scanner, or the like. These and other input devices may be connected to the processing unit 32 through a serial port interface 56 that is coupled to the system bus 38, or may be collected by other interfaces, such as a parallel port interface 52, game port or a universal serial bus (USB). Further, information may be printed using printer 54. The printer 54, and other parallel input/output devices may be connected to the processing unit 32 through parallel port interface 52. A monitor 36, or other type of display device, is also connected to the system bus 38 via an interface, such as a video input/output 34. In addition to the monitor 36, server 10 may include other peripheral output devices (not shown), such as speakers or other audible output.

As discussed above, server 10 may communicate with other electronic devices such as application 18 and user device 14. For example, server communications with application 18 and/or user device 14 may occur on a non-public network, or may be over a SSL (Secure Sockets Layer) channel secured by Certificate base authentication. Application 18 and user device 14 may include many or all of the elements described above relative to server 10. For example, user device 14 may include a processing unit, system memory, system bus, video I/O, monitor, clock, hard disk drive interface, hard disk drive, hard disk, external disk drive interface, external disk drive, parallel port interface, printer, serial port interface, input devices (such as mouse, keyboard, etc.), network I/O and modem. In this manner, user device 14 may communicate with application 18 and server 10.

To communicate, server 10 may operate in a networked environment using connections (wired, wireless or both wired and wireless) to one or more electronic devices. FIG. 4 depicts the computer environment networked with application 18 and user device 14. The logical connections depicted in FIG. 4 include a local area network (LAN) 66 and a wide area network (WAN) 68. Such networking environments are commonplace in offices, enterprise-wide computer networks, intranets and the Internet.

When used in a LAN networking environment, server 10 may be connected to the LAN 66 through a network I/O 64. When used in a WAN networking environment, server 10 may include a modem 62 or other means for establishing communications over the WAN 68. The modem 62, which may be internal or external to server 10, is connected to the system bus 38 via the serial port interface 56. In a networked environment, program modules depicted relative to server 10, or portions thereof, may be stored in a remote memory storage device resident on or accessible to application 18 or user device 14. It will be appreciated that the network connections shown are exemplary and other means of establishing a communications link between the electronic devices may be used.

With reference to FIG. 5, there is shown a block diagram of an exemplary electronic signature engine 20 depicted in FIG. 1. As discussed above, the electronic signature engine 20 may be resident on or accessible by server 10 and/or application 18. The solution may be separated into six tiers including: data; cryptography; logic; service; user presentation; and administration.

The data tier 100 may contain the object representations of the different data entities involved in the electronic signature engine. These objects may abstract all of the data provider details from the application developer and handle persisting the object data to the SQL Server database.

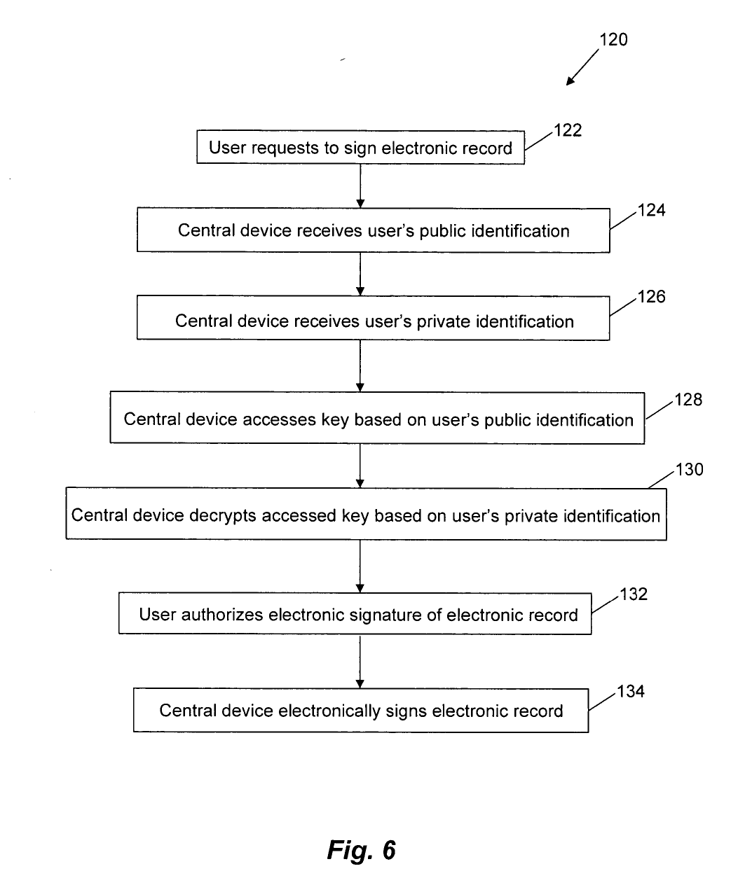

The cryptography tier 102 may contain the code that accesses different Cryptographic Service Providers (CSP). For example, the different CSPs may comprise the RSA Asymmetric CSP (using the Rivest, Shamir, and Adelman (RSA) algorithm) and the TripleDES Symmetric CSP. The different CSPs are discussed in more detail with respect to FIG. 6.

The RSA Cryptographic Service Provider may support two different functions in the engine. The first function may be to generate cryptographically random Public/Private key sets used for User signatures. This first function may be used during user registration. The second may be the storage of a Machine Encryption Key. The RSA Cryptographic Service Provider may allow the permanent storage of a key in the CSP. This key may be used to encrypt and decrypt the System Key which is stored in a database, such as an SQL Database. The System Key may be a TripleDES Symmetric Key. Since the symmetric key can encrypt large amounts of data, it may be used as the main encryption engine for the data stored in the SQL database. By using this two key encryption architecture, no private key data is accessible outside of the application, increasing the difficulty of a key being compromised.

The logic tier 104 may comprise the interface between the data tier 100 and cryptography tier 102, as shown in FIG. 5. The logic tier 104 may facilitate electronic signing by retrieving keys from the database in data tier 100 and feeding them to the cryptography engines in the cryptography tier 102, taking the generated signatures and saving them for later access, and extending the data tier object model to support the cryptographic functions for different entities.

The service tier 108 may comprise where the electronic signature engine integration may occur. If an application 18 wants to leverage the digital signature engine 20, it may call methods of the electronic signature engine 20 to submit documents, retrieve signatures, and verify document signatures.

The user presentation tier 110 may support the web application that collects user identification, verifies the document contents, and performs the signature of a document. In a typical interaction with the digital signature engine 20, a user may click on a document to be signed on an Application 18. As discussed in more detail below, Application 18 may submit that document along with the userID to the signature service. The service may pass back an encrypted Universal Resource Locator (URL) to the server 10 so that the user can be redirected. The user may be asked to identify himself or herself with public user identification (such as a userID). The user may have a chance to examine the submitted document to verify its contents before signing and then enter his or her private user identification (such as a password, PIN, shared secrets, biometric information, etc.) and click Sign. The electronic signature engine 20 may sign the document, and then redirect the user back to application 18. Finally, application 18 may request and store the final signature from the service tier 108. Further, user interaction with the user presentation tier 110 may occur over a secure SSL channel.

The administrative tier 106 may comprise an ASP.Net web application that allows the configuration of the Signature Server 10. These configuration tasks may include generating new System and Machine keys, installing web farm Machine Keys, and configuring the different calling application settings. The first time the electronic signature engine is run, a new Machine key may be generated to configure a machine key in the registry. Further, a new System key may be generated to set up a System key in the database. The data tier 100, cryptography tier 102, logic tier 104, administrative tier 106, service tier 108, and user presentation tier 110 may be generated, edited, tested, and debugged using Microsoft® Visual Studio®.

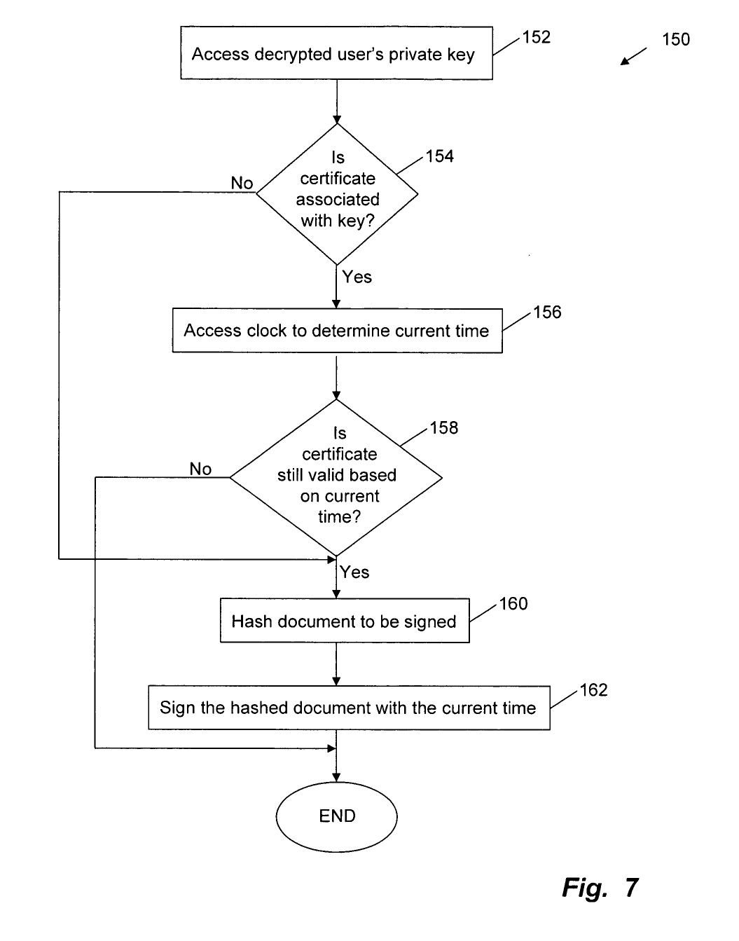

With reference to FIG. 6, there is shown a flow chart 120 of one embodiment of electronically signing an electronic record. The user may request to sign an electronic record, as shown at block 122. The request from the user may be indirectly or directly made to the central device performing the electronic signing. For example, in the configuration shown in FIG. 1 and described in more detail in FIG. 7 below, the user may request to sign the electronic record via the application 18. The application 18 may transfer the request to server 10, which is the central device performing the electronic signing. As another example, in the configurations shown in FIGS. 2 and 3, the user may directly request the central device to sign the electronic record.

The central device may then receive the user's login, as shown at block 124. The user's login may comprise data that identifies the user to the central device, such as application 18 or server 10. For example, the user's login may be a userID and may be used to access a file or a record in database 18 which is associated with the user. Similar to the request to sign, the user's login may be sent indirectly, directly, or both indirectly and directly to the central device. For example, the user may input his or her user identification (e.g., userID) to application 18. Thereafter, application 18 may send the user identification to server 10, which may perform electronic signing. When the user is redirected to server 10, server 10 may ask the user to enter the user identification. As another example, the user may send the user's login directly to the server 10 or the application 18. Further, the user's login may be sent automatically or manually. For example, if the user device is a telephone, the telephone number of the user device may be automatically entered via ANI (Automatic Number Identification) or manually by the user.

The central device may further receive the user's private identification, as shown at block 126. A user's private identification may comprise any information that is specific to the user, such as a password, PIN, shared secrets, biometric information, etc. The user's private identification may be used by the central device to ensure that the person identified is the person signing. This increases the likelihood of non-repudiation of the electronic signature.

The central device may access the key, such as based on the user's login, as shown at block 128. For example, as shown in FIGS. 1 and 2, server 10 may access the key stored in database 12. Further, the central device may decrypt the accessed key based on the user's private identification, as shown at block 130. As discussed above, the keys may be stored in a central repository (such as database 12) and encrypted individually for each user. For example, a user's private key may be encrypted, such as by using a symmetric encryption algorithm (triple DES). The encryption key may be the user's private identification, such as the user's PIN number. This additional encryption of the key adds a measure of security. Specifically, the individual encryption of a user's private key increases security of the engine, helping ensure the non-repudiation of the signature.

The user may then authorize electronic signature of the electronic record, as shown at block 132. The central device may then electronically sign the electronic record, as shown at block 134.

With reference to FIG. 7, there is shown a flow chart 150 for checking the certificate and electronically signing the electronic record. Prior to electronically signing the electronic record, the decrypted user's private key may be accessed by the central device, as shown at block 152. Associated with the key may be a certificate. As discussed in the background, the certificate may comprise a digital certificate issued by a certification authority. Certificates may include a date after which the certificate is no longer valid. As shown at block 154, it is determined whether a certificate is associated with the key. If so, the clock may be accessed to determine the current time, as shown at block 156. The time may be in any form, such as Greenwich Mean Time (GMT). Based on the current time, it is determined whether the certificate is still valid, as shown at block 158.

If the certificate is still valid, the electronic document may be electronically signed. One method of electronic signature is by hashing the electronic document, as shown at block 160, and encrypting the hash. Hash functions are commonly used in modern cryptography. These functions map binary strings of an arbitrary length to small binary strings of a fixed length, known as hash values. A cryptographic hash function has the property that it is computationally infeasible to find two distinct inputs that hash to the same value. Hash functions are commonly used with digital signatures and for data integrity. The hash is used as a unique value of fixed size representing a large amount of data. Hashes of two sets of data should match if the corresponding data also matches. Small changes to the data result in large unpredictable changes in the hash.

The hashed document with the current time may then be electronically signed, as shown at block 162. The electronic signature of the hashed document may comprise encrypting the hashed document (and potentially other information such as the current time) using the key. When using digital signatures, the digital signature may comprise the encrypted hash (and potentially other encrypted information) and additional information, such as the hashing algorithm. The hashing algorithm may be used when verifying the digital signature, as discussed below.

In one embodiment, the other information which is encrypted may comprise the time that the electronic signature was generated. The time that the electronic signature was generated may be determined by the central device which generated the signature. In previous digital signature implementations, the user device performed the digital signature. For instances where the digital signature included the time when the signature was generated, the clock of the user device typically was accessed to determine the time. However, this configuration may be unreliable. The clock of the user device is not under the control of an independent third party. Instead, the clock is under the control of an interested party, namely the user. In order to reduce the possibility of repudiation of a signature, the time when the electronic signature is generated may be determined at a central device. The central device may be a server, for example. The server may access clock 40, as shown in FIG. 4, or another time-keeping device, in order to determine the time in which the electronic signature was generated. Clock 40 is not under the control of the user, or anyone else interested in the transaction. In this manner, time-sensitive electronic signatures may have greater reliability.

Instead of the current time being electronically signed along with the hash, the current time may be integrated with the electronic document to be signed prior to hashing. For example, the current time may be appended to the electronic document. The electronic document, with the current time appended, may be hashed. The hash of the electronic document (which includes the current time) may then be electronically signed.

The electronic signature may be performed in a variety of manners. For example, the electronic signature may be performed using symmetric or asymmetric encryption.

Symmetric Encryption

Symmetric encryption, also known as Private-Key or Session Key encryption, may be used to perform a transformation on data, keeping the data from being read by third parties. Private-key encryption algorithms use a single private key to encrypt and decrypt data. The key should be secured from access by unauthorized agents because any party that has the key can use it to decrypt data. Symmetric encryption uses the same key for encryption and decryption. Private-key encryption algorithms are extremely fast (compared to public-key algorithms discussed below) and may be well suited for performing cryptographic transformations on large streams of data.

Typically, private-key algorithms, called block ciphers, may be used to encrypt one block of data at a time. Block ciphers (like RC2, DES, TrippleDES, and Rijndael) cryptographically transform an input block of n bytes into an output block of encrypted bytes. Encrypting or decrypting a sequence of bytes is typically performed block by block. Because the size of n is small (e.g., n=8 bytes for RC2, DES, and TripleDES; n=16 [the default]; n=24; or n=32 bytes for Rijndael), values larger than n should be encrypted one block at a time.

The block cipher classes may be provided in .Net base class library of Microsoft® using a chaining mode called cipher block chaining (CBC), which uses a key and an initialization vector (IV) to perform cryptographic transformations on data. For a given private key k, a simple block cipher that does not use an initialization vector will encrypt the same input block of plaintext into the same output block of ciphertext. If there are duplicate blocks within the plaintext stream, there will be duplicate blocks within the ciphertext stream. If an unauthorized user knows anything about the structure of a block of the plaintext, he or she can use that information to decipher the known ciphertext block and possibly recover the key. To combat this problem, information from the previous block is mixed into the process of encrypting the next block. Thus, the output of two identical plaintext blocks is different. Because this technique uses the previous block to encrypt the next block, an IV is used to encrypt the first block of data. Using this system, common message headers that might be known to an unauthorized user cannot be used to reverse engineer a key.

One way to compromise data encrypted with this type of cipher is to perform an exhaustive search of every possible key. Depending on the size of the key used to perform encryption, this type of search is extremely time consuming using even the fastest computers and is therefore unfeasible. Larger key sizes are more difficult to decipher. Though encryption does not make it theoretically impossible for an adversary to retrieve the encrypted data, it does raise the cost of doing so prohibitively. If it takes three months to perform an exhaustive search to retrieve data that is only meaningful for a few days, then the exhaustive search method is impractical

The disadvantage of private-key encryption is that it presumes two parties have agreed on a key and IV and communicated their values. Also, the key should be kept secret from unauthorized users. Because of these problems, private-key encryption may be used in conjunction with public-key encryption to privately communicate the values of the key and IV.

Asymmetric Encryption

Asymmetric encryption, also known as Public-Key encryption, may be used to perform a transformation on data, keeping the data from being read by third parties. Public-key encryption uses a private key that should be kept secret from unauthorized users and a public key that can be made public to anyone. Both the public key and the private key are mathematically linked; data encrypted with the public key can only be decrypted with the private key and data signed with the private key can only be verified with the public key. The public key may be made available to anyone; this public key is used for encrypting data to be sent to the keeper of the private key. Public-key cryptographic algorithms are also known as asymmetric algorithms because one key is required to encrypt data while another is required to decrypt data.

Public-key cryptographic algorithms typically use a fixed buffer size whereas private-key cryptographic algorithms typically use a variable length buffer. Public-key algorithms cannot be used to chain data together into streams in the way that private-key algorithms can because only small amounts of data can be encrypted. Because of this, a Public-Key algorithm may only encrypt small amounts of data.

Public-key encryption typically has a much larger keyspace, or range of possible values for the key, and is therefore less susceptible to exhaustive attacks wherein every possibly key is tried. A public key is easy to distribute because it does not have to be secured. Public-key algorithms can be used to create digital signatures to verify the identity the sender of data. However, public-key algorithms are extremely slow (compared to private key algorithms) and are not designed to encrypt large amounts of data. Public-key algorithms are usually useful for transferring very small amounts of data. Typically, public-key encryption is used to encrypt a key and IV to be used by a private-key algorithm. After the key and IV are transferred, then private-key encryption may be used for the remainder of the session. The public key may be attached or associated with the electronic signature. The private key may be stored at the central device, and may be accessed during signature verification.

Digital Signatures

Digital Signatures ensure that data originates from a specific party by creating a digital signature that is unique to that party. Public-key algorithms can also be used to form digital signatures. Digital signatures authenticate the identity of a sender (if one trusts the sender's public key) and protect the integrity of data. Using a public key generated by a specific user, the recipient of the specific user's data can verify that the specific user sent it by comparing the digital signature to the specific user's data and the specific user's public key.

The digital signature may be performed using asymmetric or symmetric cryptography. Using asymmetric cryptography (public-private key cryptography) to digitally sign a message, a user named Alice may first apply a hash algorithm to the message to create a message digest. The message digest may comprise a compact and unique representation of data. Alice may request that the signing function on the electronic signature engine 20 encrypt the message digest with Alice's private key to create her personal signature. Upon receiving the message and signature, the recipient named Bob may use the signature verification function on the electronic signature engine 20. The signature verification function is discussed in more detail below. The signature verification function may decrypt the signature using Alice's public key to recover the message digest, and hashes the message using the same hash algorithm that the user used. If the message digest computed exactly matches the message digest received from the user, the message came from Alice's private key and the data has not been modified. If Bob trusts that Alice is the possessor of the private key, then Bob knows that the message came from the user.

A signature can be verified by anyone because the sender's public key is common knowledge and is typically included in the digital signature format. This method does not retain the secrecy of the message; for the message to be secret, it must also be encrypted.

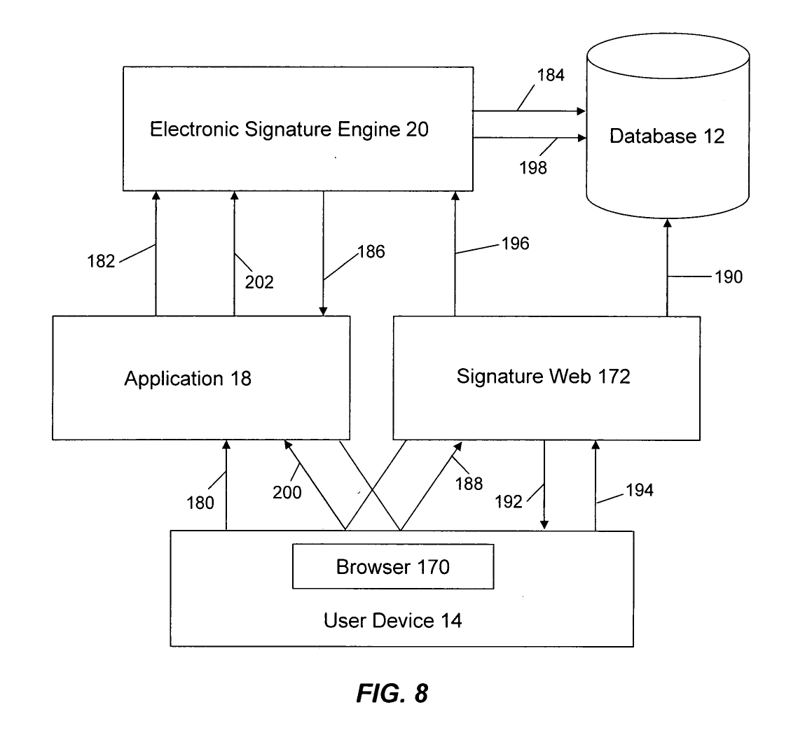

With reference to FIG. 8, there is shown a flow diagram of an exemplary electronic signing of an electronic record. FIG. 8 utilizes the configuration shown in FIG. 1 with the Internet as network 16. Application 18 in the flow diagram of FIG. 8 may support web services. Further, user device 14 may include a browser 170 for allowing the user to view web pages on the Internet. As shown in FIG. 1, server 10 may include electronic signature engine 20. Server 10 may further include a user presentation tier 110, as shown in FIG. 1. The user presentation tier 110 may comprise a signature web interface 172, as shown in FIG. 8. The user may interact with the electronic signature engine 20 via the signature web interface 172.

In the flow diagram, the user has accessed the website for application 18 and has filled out online forms, submitted data, and/or generated a document. The user at user device 14 notifies application 18 that he or she wishes to electronically sign the electronic record, as shown at step 180. When the user notifies the application that he or she wants to sign an electronic record, application 18 may send the electronic record and other information to the electronic signature engine 20, as shown at step 182. The electronic record may be sent in a variety of formats to the electronic signature engine 20. One example form is an XML format. Another example form is Base64 format. Specifically, if the electronic record is a pdf file, the Base64 document is the Base64 representation of the pdf file. Further, the other information Application N may send to the electronic signature engine comprises an ApplicationID, Application's userID, and the Redirect Page for Application N. ApplicationID identifies the application 18 to the electronic signature engine 20. Application's userID is the application's internal identification of the user which may be used by the electronic signature engine. For example, if a user logs into application 18 as BobJ, the Application userID may be BobJ as well. Application 18 may further include content type information, which indicates the type of the format for the electronic record sent from application 18 to the electronic signature engine 20. For example, if the electronic document is in pdf form, the content type information may indicate a pdf application.

The electronic signature engine 20 may store the electronic record in database 12, as shown at step 184. The storage of the electronic record may be based on the ApplicationID and the Application's userID. The electronic signature engine 20 may further assign the electronic record a unique key and SignatureID. The SignatureID may be used to identify the electronic signature generated. As shown at step 186, application 18 may receive from the electronic signature engine 20 an encrypted URL to gain access to the Signature Web 172. For example, the URL may comprise information sought by Signature Web 172 and the Redirect Page back to application 18. The Redirect Page may include custom Query String Parameters and the SignatureID appended to the URL.

As shown at step 188, application 18 may issue a redirect to Browser 170 on the user device. The redirect may use the encrypted URL obtained in step 186. As shown at step 190, Signature Web 172 may decrypt the Query String to obtain the SignatureID, ApplicationID, and Application's userID. The ApplicationID and Application's userID may be compared against the database 12. If a match is found, the electronic record is then retrieved from the database 12 via the SignatureID. If a match is not found, the user is not registered with the signature engine. The user is redirected to the User Registration functional process of the electronic signature engine 20.

As shown at step 192, Signature Web 172 may take the electronic record stored in database 12, display it to the user for verification, and request the user to enter the user's private identification (such as a PIN). If the electronic record is stored as an XML document, the Signature Web 172 may apply a custom style sheet and display the style sheet to the user for verification.

As shown at block 194, after the user verifies the electronic record displayed is the electronic record that the user wishes to sign, the user may enter the user's private identification (such as his or her PIN) and post the data back to Signature Web 172.

Signature Web 172 may transfer the user's request to sign to the electronic signature engine 20 so that the signature can be applied, as shown at step 196. The electronic signature engine 20 may retrieve the encrypted User Private Key based on the userID. The electronic signature engine 20 may decrypt the User Private Key using the user's private identification (such as a PIN). Moreover, if a digital certificate is associated with the User Private Key, the electronic signature engine may examine whether the certificate includes a time period for validity. As discussed in more detail in FIG. 7, the electronic signature engine 20 may access clock 40 in order to determine if the certificate is still valid. Further, the electronic signature engine 20 may canonicalize and sign the electronic record. The signed electronic record may further include the time of signing, as discussed in FIG. 7. Moreover, the electronic signature engine 20 may save the signed electronic record to database 12, as shown at step 198. After electronic signing, the electronic signature engine may decrypt the Redirect Page obtained in step 190. Thereafter, the Signature Web 172 may issue a redirect to Browser 170 using the decrypted redirect page, as shown at step 200.

When the user returns to application 18, application 18 may retrieve the Signed XML content from the Signature Engine based on the SignatureID that was part of the Redirect Page's Query string, as shown at step 202. The database 12 may be cleaned up of all data related to the completed signature. Alternatively, the database 12 may maintain a copy of the signed electronic record.

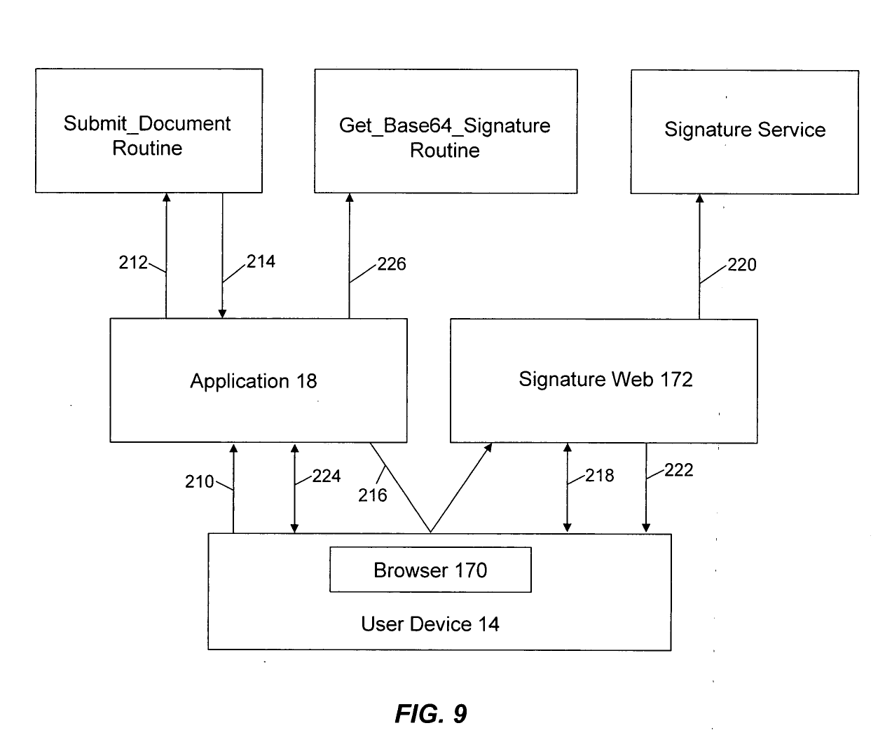

With reference to FIG. 9, there is shown a flow diagram of another exemplary electronic signing of an electronic record. FIG. 9 utilizes the configuration shown in FIG. 1 with the Internet as network 16 and with application 18 in the flow diagram of FIG. 8, though not able to support web services. At step 210, the user requests to sign an electronic record similar to step 180 in FIG. 8. At step 212, application 18 may submit the electronic record to the Signature Function of the electronic signature engine 20 using Submit_Document Routine. At step 214, the Signature Function may return the URL to gain access to the Signature Web 172, similar to step 186 in FIG. 8. At step 216, application 18 may redirect the user to the Signature Web 172, similar to step 188 in FIG. 8. At step 218, the user may register, prove his or her identity, review the electronic record, and enter a command to sign the electronic record, similar to step 192 in FIG. 8. At step 220, the electronic document may be signed and stored in database 12. At step 222, the Signature Web may redirect the user back to application 18. At step 224, the user returns back to application 18 to view a confirmation page. At step 226, application 18 requests the final signature from the Get_Base64_Signature Routine of the Signature Function of the electronic signature engine 20 and stores it in a database accessible to application 18.

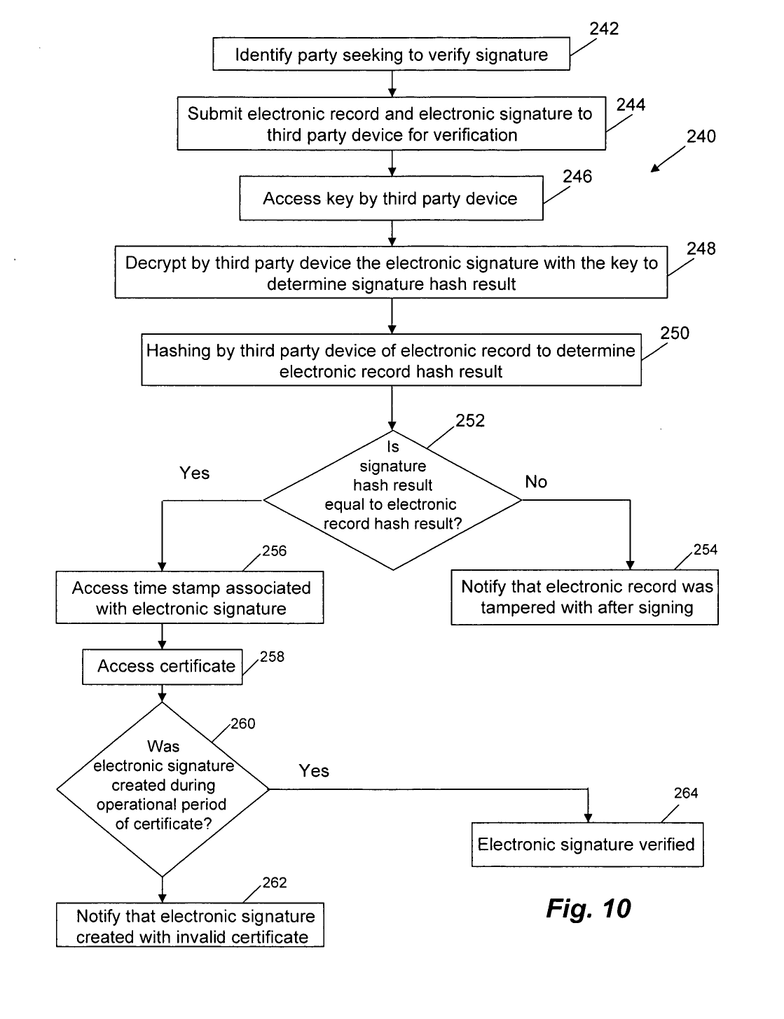

In addition to electronic signature functionality, the electronic signature engine 20 may include other functions as well, including signature verification. With reference to FIG. 10, there is shown a flow chart 240 of an exemplary signature verification process which may be performed by the electronic signature engine 20. As shown at block 242, the party seeking to verify the electronic signature may be identified. In the configuration shown in FIG. 1 in which server 10 includes electronic signature engine 20, a user device 14, communicating with application 18, may seek to verify an electronic signature. Application 18 may redirect user device to server 10 to verify the electronic signature at server 10. Alternatively, user device 14 may seek to verify an electronic signature by directly accessing server 10. In still an alternate embodiment, application 18 may seek to verify an electronic signature.

Further, the electronic record and the electronic signature may be submitted to the central device, as shown at block 244. In the configuration of FIG. 1, application 18 may submit the electronic record and electronic signature to server 10. Alternatively, user device 14 may submit the electronic record and electronic signature to server 10. The key may be accessed by the central device, as shown at block 246. If the key is associated with the electronic signature, the central device may access the key via the electronic signature. If the key is not associated with the electronic signature, the electronic signature or the electronic record may include the signer's identification. For example, a userID may be associated with the electronic signature. Based on the userID, the central device, such as server 10, may access database 12 to retrieve the key.

As discussed above, to determine whether the electronic record has been tampered with, the hash generated at the time of the electronic signature may be compared with the hash currently generated. To determine the hash generated at the time of the electronic signature (i.e., the electronic signature hash result), the central device may decrypt the electronic signature using the accessed key, as shown at block 248. Further, the central device may hash the electronic record to determine an electronic record hash result, as shown at block 250. The electronic signature hash result and the electronic record hash result may be compared with one another, as shown at block 252. If the hashes are not equal, the electronic record has been modified since the electronic signature was generated. The party seeking verification of the signature is notified of this, as shown at block 254.

If the hashes are equal, the electronic record has not been modified since the electronic signature was generated. If a time stamp is associated with the electronic signature, it is accessed, as shown at block 256. Further, if a certificate is associated with the electronic signature, it is accessed as well, as shown at block 258. The time stamp from the electronic signature and the operational period of the certificate are compared to determine if the electronic signature was created during the operational period, as shown at block 260. If the answer is yes, the electronic signature is verified, as shown at block 264. If the answer is no, the electronic signature was created with an invalid certificate (i.e., the certificate was not legitimate at the time of signing). The party seeking verification of the signature is notified of this, as shown at block 262.

The electronic signature engine 20 may further include the functionality of user registration. A user may register with the electronic signature engine 20 either once or multiple times. For example, the user may register once so that the user may be identified for any application 18 which may call server 10. Alternatively, the user may register multiple times, enrolling for each service and uniquely identifying the user on a per application basis.

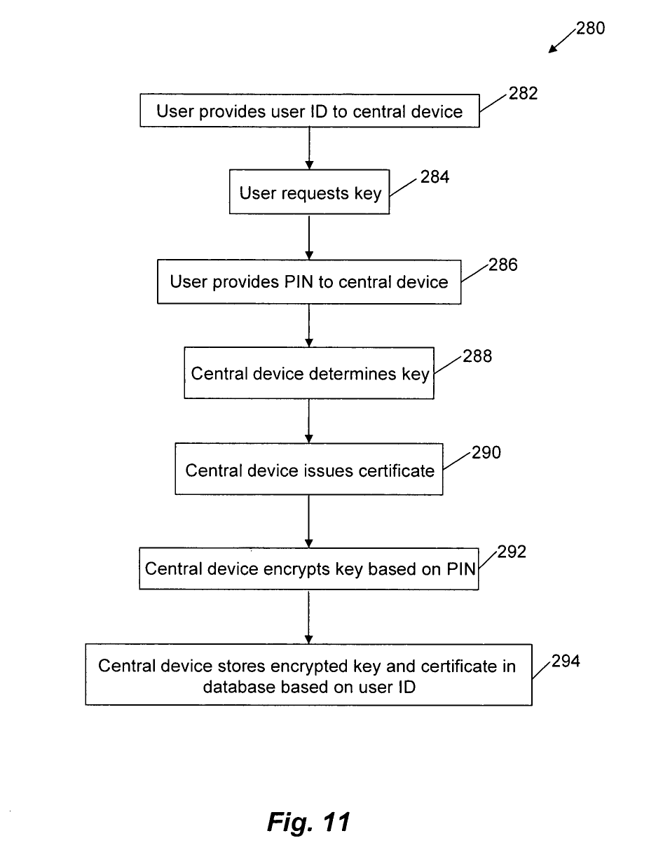

The user may register with the electronic signature engine 20 in order to have a key assigned to the user. The key may be used when using the electronic signing functionality of the electronic signature engine 20. With reference to FIG. 11, there is shown a flow chart 280 of an exemplary user registration process. The user registration process may be implemented at the request of a user. Alternatively, if a user during the electronic signature process does not have a key assigned, the user may be directed to the user registration process.

As shown at block 282, the user may provide a userID to the central device (e.g., server 10). Alternatively, the userID may be sent to the central device by application 18. As discussed above, the userID may comprise the application's internal identification of the user. The userID may further be used to reference a particular user by the electronic signature engine 20. The user may request a key, as shown at block 284. Further, the user may provide a PIN, or some other private identification such as a password, shared secrets, or biometric information, to the central device, as shown at block 286. In one embodiment, a secure known fact registration system may be implemented in the user registration process of the electronic signature engine 20. For example, a fact known only to a specific user may be included in the user registration process in order to increase the likelihood that the person registering is the specific user.

The central device may determine the key (such as the public-private key combination in the case of an asymmetric encryption), as shown at block 288. As discussed above, the key may be randomly generated by the central device. The central device may further issue a certificate, as shown at block 290. The user registration process may further allow for revocation of certificates. The third party device may encrypt the key(s) using the PIN (or some other private identification), as shown at block 292. As discussed above, the key may be encrypted with the PIN using a symmetric key algorithm (triple DES) before it is saved in database 12. The central device may store the encrypted key(s) and certificate in database 12 based on the userID, as shown at block 294.

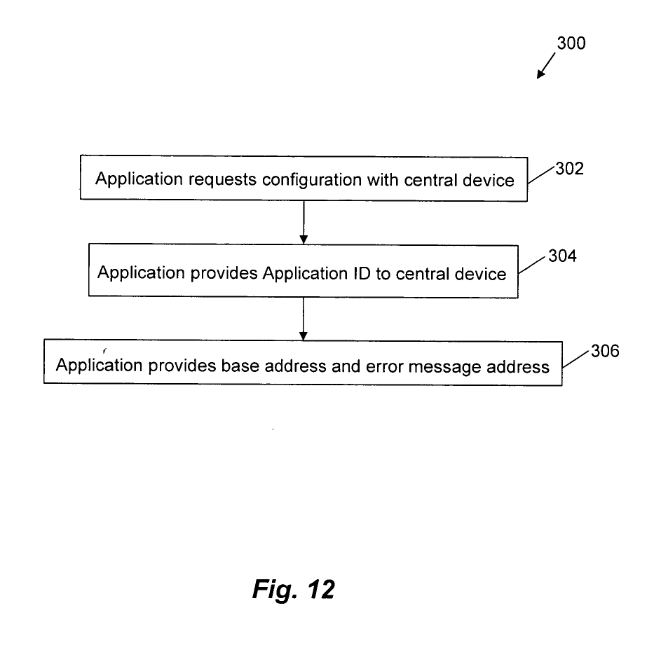

The electronic signature engine 20 may also include the functionality of application configuration. An application 18 may be configured with the electronic signature engine 20 in order to use the functions of the engine. With reference to FIG. 12, there is shown a flow chart 300 of an exemplary application configuration process. The application 18 may request configuration with the central device, as shown at block 302. The application 18 may provide an application ID to the central device, as shown at block 304. Alternatively, the central device may issue an application ID to the application 18. The application ID may be used to identify the application 18 to the central device when the application 18 later uses the functions of the electronic signature engine 20. The application may further provide other information to the electronic signature engine 20, such as a base address, error message address, signature return address, etc. as shown at block 306. For example, if an application sends an electronic record for signature to the electronic signature engine 20, and the user fails to sign the electronic record (such as failing to provide a PIN), an error message may be sent to the error message address to notify application 18. As another example, the application configuration may include an address to return the signature to the application when the signing process has completed.

While this invention has been shown and described in connection with the preferred embodiments, it is apparent that certain changes and modifications in addition to those mentioned above may be made from the basic features of this invention. In addition, there are many different types of computer software and hardware that may be utilized in practicing the invention, and the invention is not limited to the examples described above. The invention was described with reference to acts and symbolic representations of operations that are performed by one or more electronic devices. As such, it will be understood that such acts and operations include the manipulation by the processing unit of the electronic device of electrical signals representing data in a structured form. This manipulation transforms the data or maintains it at locations in the memory system of the electronic device, which reconfigures or otherwise alters the operation of the electronic device in a manner well understood by those skilled in the art. The data structures where data is maintained are physical locations of the memory that have particular properties defined by the format of the data. While the invention is described in the foregoing context, it is not meant to be limiting, as those of skill in the art will appreciate that the acts and operations described may also be implemented in hardware. Accordingly, it is the intention of the Applicants to protect all variations and modification within the valid scope of the present invention. It is intended that the invention be defined by the following claims, including all equivalents.

1. A network server for a computer network system to electronically sign electronic records from one or more computers, the network server comprising:
a processing unit;
a memory;
an electronic signature engine stored in the memory and executable on the processing unit, the electronic signature engine retrieving user signing data, accessing an electronic record, receiving authorization data from a user of a user device to electronically sign the electronic record, and electronically signing the electronic record using the user signing data.

2. The network server of claim 1, wherein the user signing data is stored in the memory.

3. The network server of claim 2, wherein the user signing data comprise a key.

4. The network server of claim 1, wherein accessing an electronic record comprises generating the electronic record at the network server system.

5. The network server of claim 1, wherein the user device communicates with the network server via a network; and
wherein accessing an electronic record comprises receiving the electronic record from the user device via the network.

6. The network server of claim 1, wherein an application device communicates with the network server via a network; and
wherein accessing the electronic record comprises receiving the electronic record from an application device.

7. The network server of claim 1, wherein the user device communicates with the network server via a network; and
wherein receiving authorization data from a user comprises sending the authorization data from the user device to the network server via the network.

8. The network server of claim 1, wherein an application device communicates with the network server via a network; and
wherein receiving authorization data from a user comprises sending the authorization data via the application device to the network server via the network.

9. The network server of claim 1, wherein electronically signing comprises associating data, an electronic sound, a symbol, or a process with the electronic record.

10. The network server of claim 1, wherein electronically signing comprises converting the electronic record into a hash value using a hash function, and encrypting the hash value using the user signing data.

11. The network server of claim 1, wherein the electronic signature engine further receives identification information from the user device; and
wherein the electronic signature engine retrieving user signing data is based on the identification information.

12. The network server of claim 11, wherein receiving identification information comprises receiving a user login.

13. The network server of claim 11, wherein receiving identification information comprises receiving user private identification.

14. The network server of claim 13, wherein the user private identification comprises a PIN.

15. The network server of claim 14, wherein receiving identification information from the user device comprises providing a user login; and
wherein retrieving user signing data comprises accessing, by the network server, the memory based on the user login to retrieve the user signing data.

16. The network server of claim 11, wherein receiving identification information from the user device comprises receiving user private identification; and
wherein the electronic signature engine decrypts the user signing data based on the user private identification.

17. The network server of claim 1, further comprising:
a clock;
wherein the electronic signature engine accesses the clock for a time stamp; and
wherein electronically signing the electronic record is based on the time stamp.

18. A central device, in a system with a user device which authorizes electronically signing an electronic record, the central device comprising logic for:
determining user signing data for a user at the user device;
receiving authorization data from the user of the user device to electronically sign the electronic record; and
electronically signing the electronic record based on the user signing data.

19. The central device of claim 18, wherein the central device comprises a server;
wherein the user device communicates with the server via a network; and
wherein receiving authorization data from the user comprises receiving the authorization data from the user device via the network.

20. The central device of claim 18, wherein the system further comprises an application device;
wherein the central device comprises a server;
wherein the application device communicates with the server via a network; and
wherein receiving authorization data from the user comprises receiving the authorization data from the user device via the application device.

21. A network server for a computer network system to verify electronically signed records, the network server comprising:
a processing unit;
a memory;
an electronic signature engine stored in the memory and executable on the processing unit, the electronic signature engine accessing an electronic record and an electronic signature, receiving authorization data to verify the electronic signature from a user of a user device, and verifying that the electronic record has not been altered since the electronic signature was generated.

22. The network server of claim 21, wherein the user device communicates with the network server via a network; and
wherein receiving authorization data from the user comprises receiving the authorization data from the user device via the network.

23. The network server of claim 21, wherein the electronic signature engine determines a key for the electronic signature, and verifies the electronic signature using the key.

24. A method of electronically signing an electronic record, the method operating in a system comprising a user device and a central device, the method comprising:
determining, by the central device, user signing data for a user at the user device;
receiving, by the central device, authorization data from a user of the user device to electronically sign the electronic record; and
electronically signing, by the central device, the electronic record based on the user signing data.

25. The method of claim 24, wherein the user signing data comprises at least one key.

26. The method of claim 24, wherein the central device comprises a server;
wherein the user device communicates with the server via a network; and
wherein receiving authorization data from the user comprises receiving the authorization data from the user device via the network.

27. The method of claim 24, wherein the system further comprises an application device;
wherein the central device comprises a server;
wherein the application device communicates with the server via a network; and
wherein receiving authorization data from the user comprises receiving the authorization data from the user device via the application device.

28. The method of claim 24, wherein electronically signing comprises associating data, an electronic sound, a symbol, or a process with the electronic record.

29. The method of claim 28, wherein associating comprises attaching the data, electronic sound, symbol or process to the electronic record.

30. The method of claim 24, wherein electronically signing comprises converting the electronic record into a hash value using a hash function, and encrypting the hash value using the user signing data.

31. The method of claim 30, wherein the user signing data comprises a key; and
wherein encrypting the hash value comprises digitally signing the electronic record with the key.

32. The method of claim 24, further comprising identifying the user at the user device; and
wherein determining user signing data is based on identifying the user.

33. The method of claim 32, wherein identifying the user at the user device comprises receiving a user login.

34. The method of claim 32, wherein identifying the user at the user device comprises providing user private identification.

35. The method of claim 34, wherein the user private identification comprises a PIN.

36. The method of claim 32, wherein identifying a user at a user device comprises receiving a user login; and
wherein determining user signing data comprises accessing, by the central device, a memory based on the user login to retrieve the user signing data.

37. The method of claim 32, wherein identifying a user at a user device comprises receiving user private identification; and
wherein determining user signing data comprises decrypting the user signing data based on the user private identification.

38. The method of claim 24, wherein the user device communicates with the central device via a network; and
further comprising receiving the electronic record at the central device from the user device via the network.

39. The method of claim 24, wherein the system further comprises an application device;
wherein the central device comprises a server;
wherein the application device communicates with the server via a network; and
wherein receiving the electronic record comprises receiving the electronic record from the application device via the network.

40. The method of claim 24, further comprising generating the electronic record at the central device.

41. The method of claim 24, wherein the central device comprises a server; and
further comprising sending the electronically signed electronic record from the server to the user device.

42. The method of claim 24, further comprising:
determining, by the central device, a time stamp; and
wherein electronically signing is based on the time stamp.

43. The method of claim 42, wherein electronically signing comprises converting the electronic record and time stamp into a hash value using a hash function, and encrypting the hash value using the user signing data.

44. The method of claim 42, wherein electronically signing comprises converting the electronic record into a hash value using a hash function, and encrypting the hash value and the time stamp using the user signing data.

45. The method of claim 42, wherein determining a time stamp comprises accessing a clock by the central device.

46. The method of claim 45, wherein the clock is protected from tampering by the user of the user device.

47. The method of claim 24, wherein the user signing data comprises a key;
wherein the key has associated with it a certificate comprising a revocation date; and
further comprising:
determining, by the central device, a current time; and
determining whether the key is still valid based on the revocation date for the key and the current time.

48. A method for electronically signing, the method operating in a system comprising an application device, a user device, a server, and a network, the network for the application device, user device, and server to communicate with one another, the method comprising:
generating an electronic record;
sending the electronic record from the application device to the server;
redirecting the user device from the application device to the server;
identifying a user at the user device to the server;
determining at least one key based on the identification of the user; and
electronically signing, by the server, the electronic record using the key.

49. The method of claim 48, wherein generating an electronic record comprises generating an electronic record at the application device.

50. The method of claim 48, further comprising, after sending the electronic record from the application device to the server, sending a redirect address from the server to the application device; and
wherein redirecting the user device comprises the application device redirecting the user device to the redirect address.

51. The method of claim 48, further comprising, after identifying a user, reviewing the electronic record by the user of the user device and authorizing, by the user, electronically signing of the electronic record.

52. The method of claim 48, further comprising:
determining, by the server, a time stamp; and
wherein electronically signing is based on the time stamp.

53. A method for verifying an electronic signature with the steps being performed by the central device, the method comprising:
receiving an electronic record and an electronic signature from a communication device;
receiving authorization data to verify the electronic signature from the communication device;
determining a key for the electronic signature; and
verifying using the key that the electronic record has not been altered since the electronic signature was generated.

54. The method of claim 53, wherein the communication device comprises a user device.

55. The method of claim 53, wherein the central device comprises a server.

56. The method of claim 53, wherein verifying comprises:
decrypting the electronic signature using the key;
hashing the electronic record; and
comparing the decrypted electronic signature with the hashed electronic record.

57. A method for generating user signing data for an electronic signature by a central device, the method operating in a system comprising a user device, the central device, and a network, the user device and central device communicating via the network, the method comprising:
identifying a user at the user device;
receiving a request from the user at the user device for user signing data;
generating the user signing data by the central device; and
storing the user signing data in a database based on the identification of the user, the database being accessible by the central device but not being accessible by the user device; and
ending communication between the central device and user device without sending the user signing data to the user device.

58. The method of claim 57, wherein the user signing data comprises at least one key.

59. The method of claim 57, wherein identifying a user at a user device comprises providing user private identification.

60. The method of claim 59, further comprising encrypting the user signing data based on the user private identification; and
wherein storing the user signing data comprises storing the encrypted user signing data.
